(19) United States
(12) Patent Application Publication
(10) Pub. No.: US 2006/0062160 A1
(43) Pub. Date: Mar. 23, 2006

(54) IP address management method for IPC

(75) Inventors: Su-Hyung Kim, Seoul (KR); Tae-Sung Park, Yongin-si (KR); Seong-Ha Kim, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/202,502

(22) Filed: Aug. 12, 2005

(30) Foreign Application Priority Data
Sep. 23, 2004 (KR) 2004-76339

(51) Int. Cl. H04L 12/28

(52) U.S. Cl. 370/257

(57) ABSTRACT

A method for managing an IP address statically allocated to a slave slot through a master slot is disclosed If the power of a slave slot is on, confirming whether the slave slot has a static IP, and if not, confirming whether the slave slot has a DHCP (Dynamic Host Configuration Protocol) IP. Confirming whether the slave slot has a slot ID from a backplane if the slave slot has the static IP, and confirming whether the slave slot has the slot ID from the backplane if the slave slot has the DHCP IP. Confirming whether a master slot has a static IP, and performing an IPC communication if the slave slot has the slot ID. If the slave slot has neither the static IP nor the DHCP IP, a discovery operation is performed to obtain the IP information if the master slot does not have the static IP.

### CLAIM OF PRIORITY

This application claims priority to an application entitled “IP Address Management Method for IPC,” filed in the Korean Intellectual Property Office on Sep. 23, 2004 and assigned Serial No. 2004-76339, the contents of which are hereby incorporated by reference.

### BACKGROUND OF THE INVENTION

1. Field of the Invention

The present invention relates generally to an IPC (Inter-Processor Communication) system in an EPON (Ethernet Passive Optical Network), and more particularly to a method for managing an IP address allocated to a slave slot through a master slot statically.

2. Description of the Related Art

FIG. 1 is a block diagram illustrating the construction of a general IPC communication system.

As shown, the general IPC communication system includes a backplane 11 transmitting data using an Ethernet communication protocol and performing data transmission/reception through a plurality of slots, a master slot 12 having a static IP address and managing addresses for an IPC communication and so on, and at least one slave slot 13-1 to 13-n having static IP addresses or dynamic IP addresses and performing IPC communications with the master slot 12 or other slave slots through the backplane 11. The master slot 12 communicates with the slave slots using various kinds of control information. If the master slot 12 has a static IP address and the slave slots 13-1 to 13-n also have the static IP addresses, the master slot 12 or the slave slots 13-1 to 13-n must know the IP address or MAC address of an receiving party for effectuate mutual communications.

A first method of managing an IP address for an IPC is to perform an ARP/RARP (Address Resolution Protocol/Reverse ARP). Here, the ARP is a protocol used to enable an IP address correspond to a physical network address (i.e., MAC address) on an IP network. In this case, the physical network address (i.e., MAC address) means a 48-bit network card address of an Ethernet or token ring.

If an IP host A intends to transmit an IP packet to an IP host B, but does not know the physical network address of the IP host B, it transmits an ARP packet having a destination IP address B and a broadcasting physical network address “FFFFFFFFFFFF” on the network using the ARP protocol. Then, if the IP host B receives the ARP packet having the IP address of the IP host B as the destination IP address, it sends its own physical network address to the IP host A as a reply. The collected IP addresses information and the corresponding physical network addresses are stored in the form of a table in a memory called an ARP cache of the respective IP host, and then reused during the next packet transmission.

In contrast, if the IP host knows its own physical network address, but does not know its own IP address, it requests the IP address to a server using the RARP.

As described above, in the case in which the master slot 12 or the slave slot does not know the opposite party's IP address statically allocated thereto, the protocol such as the ARP/RAEP must be additionally provided in order to locate the opposite party's address.

A second method of managing an IP address for an IPC is to use a DHCP (Dynamic Host Configuration Protocol) through which network managers can centrally manage and allocate IP addresses on the network. In the case of using the DHCP, the master slot 12 is provided with a DHCP server, which manages the addresses by dynamically performing an IP allocation with respect to the slave slots 13-1 to 13-n.

However, the above-described methods for managing an IP address for an IPC using the ARP/RARP or the DHCP are not suitable to realize an efficient management of the IP addresses statically allocated. That is, the ARP table used in the IP address management method using the ARP/RARP has a problem that its update period cannot satisfy the function used in the system. For example, in the case in which the slave slot is removed from the system, the system software that monitors information of the ARP table cannot monitor the removal of the slave slot in real time. Further, in implementing stage of the system, corresponding data must be inputted in advance so that the respective slots can use the IP addresses respectively allocated to boards packaged into the respective slots.

Specifically, since the IP address management method using the ARP/RARP is performed by operating an application software for monitoring the ARP table, it is technically difficult to perform a real-time monitoring. Also, since the opposite party's IP address is inputted in advance, the fluidity according to the change of a situation is lacking, and this may cause waste of unnecessary time during recoding process.

Meanwhile, in the case in which the master slot 12 is provided with the DHCP server and the IP allocation is dynamically performed with respect to the slave slots 13-1 to 13-n, the address management can be performed, but the system that uses the IP address by obtaining the slot ID from the backplane 11 requires an additional method for the slot address management.

### SUMMARY OF THE INVENTION

Accordingly, the present invention has been designed to solve the above and other problems occurring in the prior art and provides additional advantages, by providing a terminal adaptor device capable of performing an IEEE 1394-to-Ethernet conversion for processing by hardware data inputted/outputted in a home network system based on an IEEE 1394.

Another aspect of the present invention is to provide a terminal adaptor device capable of performing an IEEE 1394-to-Ethernet conversion for improving the performance and reducing the burden of a CPU (Central Processing Unit) by constructing a part of an IP processing function of an IEEE 1394 by hardware.

In one embodiment, there is provided an IP management method between slots for an IPC (Inter-Processor Communication), comprising a first step of, if the power of a slave slot is on, confirming whether the slave slot has a static IP, and if the slave slot does not have the static IP, confirming whether the corresponding slave slot has a DHCP (Dynamic Host Configuration Protocol) IP, a second step of confirming whether the slave slot has a slot ID from a backplane if the slave slot has the static IP as a result of the confirmation in the first step, a third step of confirming whether the slave slot has the slot ID from the backplane if the slave slot has the DHCP IP as a result of the confirmation in the first step, a fourth step of confirming whether a master slot has a static IP, and if the master slot has the static IP, performing an IPC communication if the slave slot has the slot ID as a result of the confirmation in the second and third steps, a fifth step of performing a discovery operation for obtaining IP information if the slave slot has neither the static IP nor the DHCP IP, and a sixth step of performing the discovery operation for obtaining the IP information if the master slot does not have the static IP in the fourth step.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating the construction of a general IPC communication system;

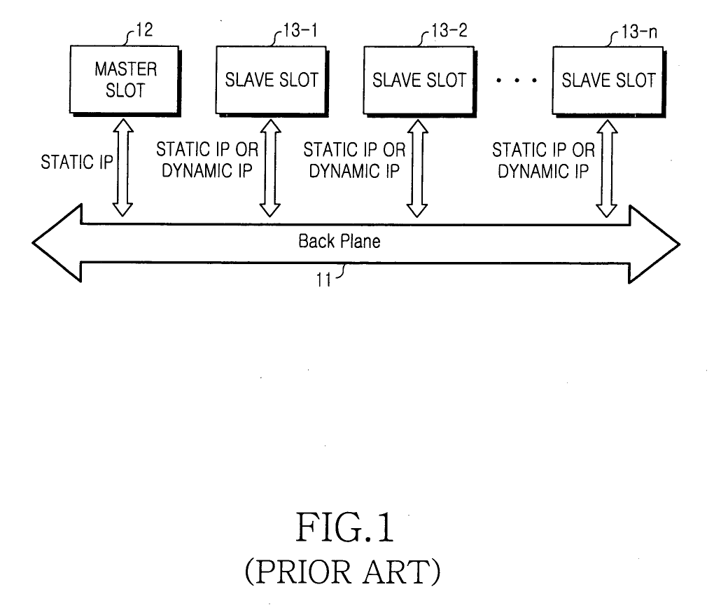

FIG. 2 is a flowchart illustrating a conventional IP address management method for an IPC;

FIG. 3 is a block diagram illustrating the construction of an IP management device for an IP allocation used in an IP address management method for an IPC according to the present invention;

FIG. 4 is a flowchart illustrating an IP management method for an IPC according to an embodiment of the present invention;

FIG. 5 is a timing diagram explaining a discovery process in the IP address management method for an IPC according to an embodiment of the present invention; and

FIG. 6 is a view illustrating the structure of messages used in the discovery process according to an embodiment of the present invention.

### DETAILED DESCRIPTION

Embodiments of the present invention will be described in detail hereinafter with reference to the accompanying drawings. In the following description of the present invention, the same drawing reference numerals are used for the same elements even in different drawings. For the purposes of clarity and simplicity, a detailed description of known functions and configurations incorporated herein will be omitted when it may obscure the subject matter of the present invention.

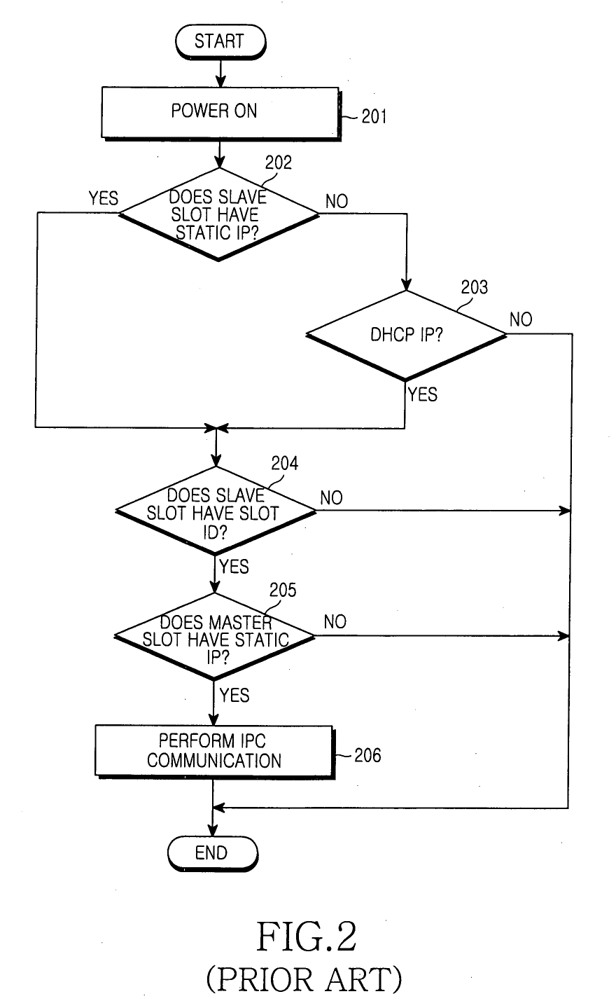

FIG. 2 is a flowchart illustrating a conventional IP address management method for an IPC.

Referring to FIG. 2, if the power of a slave slot is on (step 201), it is confirmed whether or not the corresponding slave slot has a static IP (step 202). If the slave slot does not have the static IP as a result of confirmation, it is confirmed whether or not the corresponding slave slot has a DHCP IP (step 203).

In the case in which the slave slot has the static IP (step 202) or the DHCP IP (step 203), it is then confirmed whether the slave slot has a slot ID from a backplane (204).

If the slave slot has the slot ID, it is confirmed whether a master slot has a static IP (step 205), and if so, an IPC communication is performed (step 206).

Meanwhile, if the corresponding slave slot has neither the static IP nor the DHCP IP (i.e., the slave slot does not have IP information), the corresponding slave slot does not have the slot ID, and the master slot does not have the static IP, the process ends as it is.

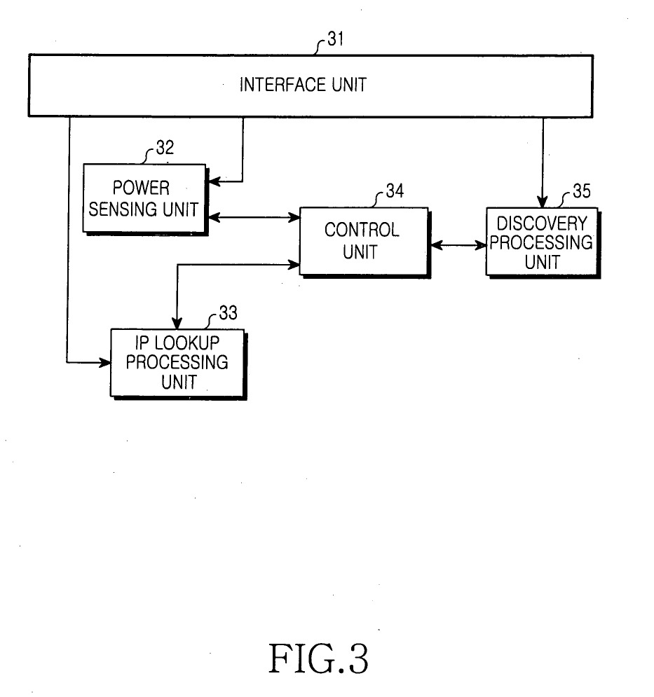

FIG. 3 is a block diagram illustrating the construction of an IP management device for an IP allocation used in an IP address management method for an IPC according to the present invention.

Referring to FIG. 3, the IP management device included in a slot for an IP allocation used in the IP address management method for an IPC according to the present invention includes an interface unit 31 for connection to an outside, a power sensing unit 32 for sensing the power supply state of a specified slot from the interface unit 31, an IP lookup processing unit 33 for confirming IP information of the specified slot from the interface unit 31, a control unit 34 controlling a discovery operation using information transferred from the power sensing unit 32 and the IP lookup processing unit 33, and a discovery processing unit 35 for performing the discovery operation under the control of the control unit 34.

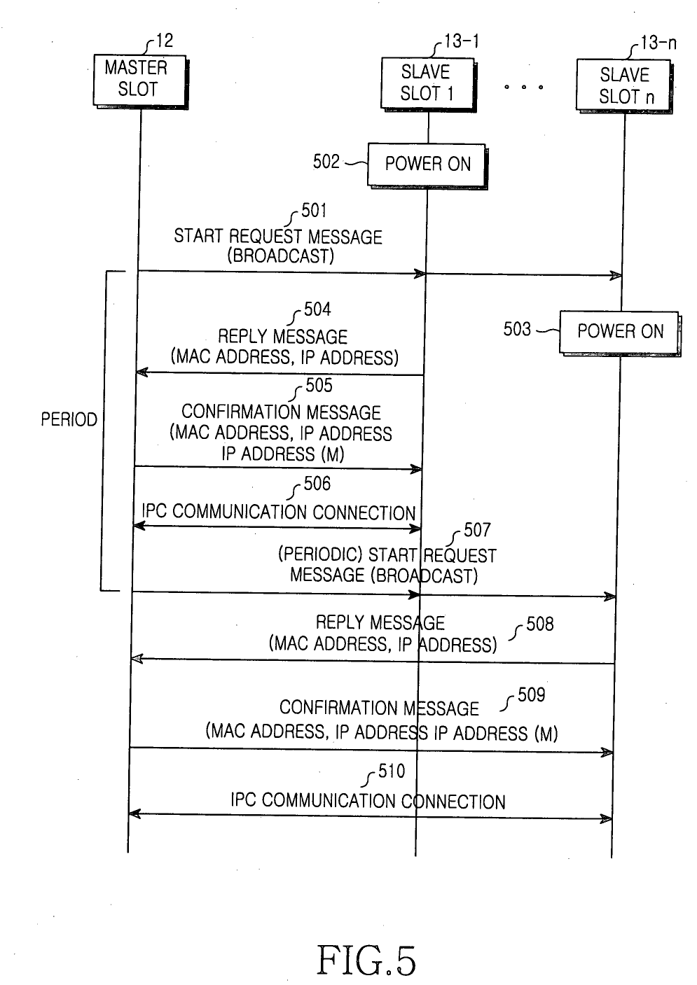

Particularly, the discovery operation mentioned in the embodiment of the present invention, which will be explained later with reference to FIG. 5, is performed in a manner that a master slot receives information of slave slots through a periodic messaging process for all of the slave slots, and sends information that includes its own information to the slave slots in reply, so that an IPC communication between the slots becomes possible.

Various functional operations associated with the IP management device may be implemented in whole or in part in one or more software programs/signal processing routines stored in a program memory and executed by a processor. In other embodiments, however, hardware circuitry may be used in place of, or in combination with, software instructions to implement the invention. Since it is apparent to those skilled in the art to which the present invention belongs to construct the device of FIG. 3 by software and mount the device on the system, the detailed explanation thereof will be omitted.

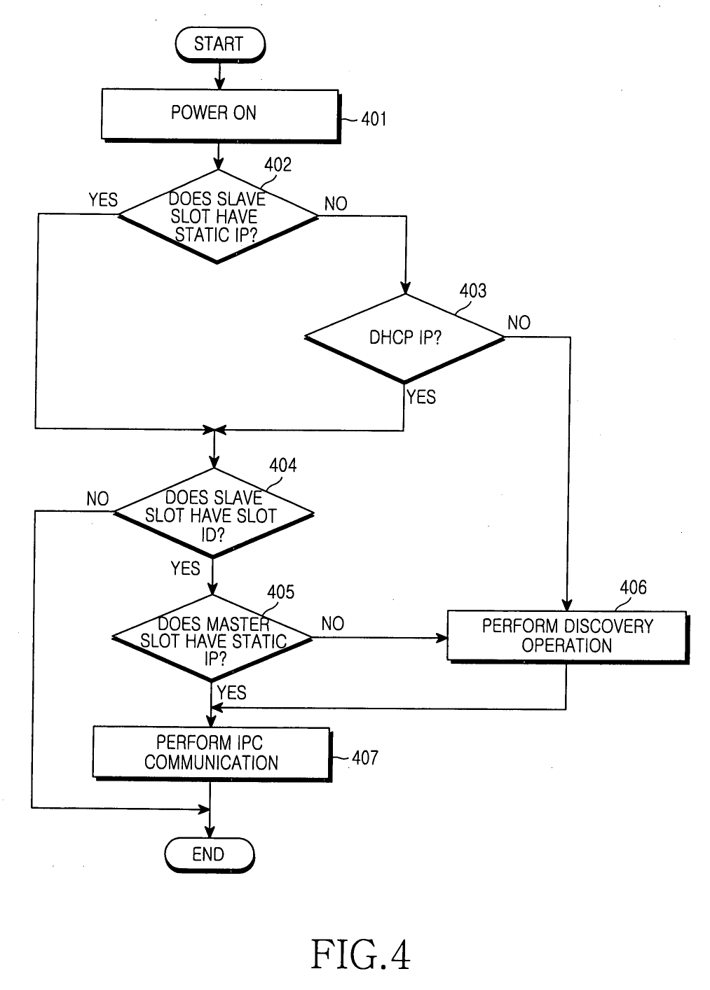

FIG. 4 is a flowchart illustrating the IP management method for an IPC according to an embodiment of the present invention.

Referring to FIG. 4, if the power of a slave slot is on (step 401), it is confirmed whether the corresponding slave slot has a static IP (step 402). If the corresponding slave slot does not have the static IP as a result of confirmation, it is confirmed whether the corresponding slave slot has a DHCP IP (step 403).

If the slave slot has a static IP (step 402) or a DHCP IP (step 403), it is confirmed whether the slave slot has a slot ID from a backplane (step 404).

If the slave slot has a slot ID, it is confirmed whether the master slot has a static IP (step 405), and if so, the IPC communication starts (step 407).

Meanwhile, if the corresponding slave slot has neither the static IP nor the DHCP IP (i.e., the slave slot does not have IP information) and the master slot does not have the static IP, the discovery operation is performed (step 406), and then the IPC communication starts (step 407). Here, the discovery operation is performed in a manner so that the master slot receives information on the slave slots through a periodic messaging process for all of the slave slots, and sends information that includes its own information to the slave slots in reply, so that then IPC communication between the slots becomes possible. That is, the discovery operation provides a reply operation to the discovery operation performed in a state when the power is on. Although the IPC communication is generally performed according to the conventional method, the master slot operates as a slot in the present invention according to the discovery operation in the present invention ( explained later with reference to FIG. 5) if the IPC communication cannot be performed by the conventional method (that is, the corresponding slave slot has neither the static IP nor the DHCP IP (i.e., the slave slot does not have IP information) and the master slot does not have the static IP).

Meanwhile, if the corresponding slave slot does not have the slot ID (step 404), the process ends.

FIG. 5 is a timing diagram explaining the discovery process in the IP address management method for an IPC according to an embodiment of the present invention.

Referring to FIG. 5, the active master slot 12 periodically broadcasts a request message for the start of the slave slots 13-1 to 13-n (step 501).

The slave slot 13-1 which has received the broadcasting message and the power of which is on (step 502) transmits a reply message that includes its own MAC address and IP address to the master slot 12 (step 504).

Then, the master slot 12 transfers a confirmation message which further includes the reply message and its own IP to the slave slot. In this case, the reason why the master slot resends the IP address and the MAC address received from the slave slot 13-1 is that the slave slot 13-1 is allowed to use the corresponding address requested by the slave slot 13-1. Accordingly, the slave slot 13-1 can communicate with the master slot 12 for the first time.

If the confirmation message is transferred, the IPC communication connection is made between the master slot 12 and the slave slot 13-1 (step 506).

Meanwhile, with respect to other slave slots the powers of which are on, the above-described process is repeatedly performed.

That is, the active master slot 12 periodically broadcasts the request message for the start of the slave slots 13-1 to 13-n (step 507), and the slave slot 13-n which has received the broadcasting message and the power of which is on (step 503) transmits the reply message that includes its own MAC address and IP address to the master slot 12 (step 508).

Then, the master slot 12 transfers the confirmation message that further includes the reply message and its own IP to the slave slot (step 509) to connect the IPC communication (step 510).

In the above-described process, if replies are simultaneously inputted from a plurality of slave slots, the operation for the IPC communication is performed according to the size of a FIFO (First In First Out) buffer of the master slot.

If the master slot and the slave slots are all packaged in the discovery process, the messages transferred from the slave slots are disregarded.

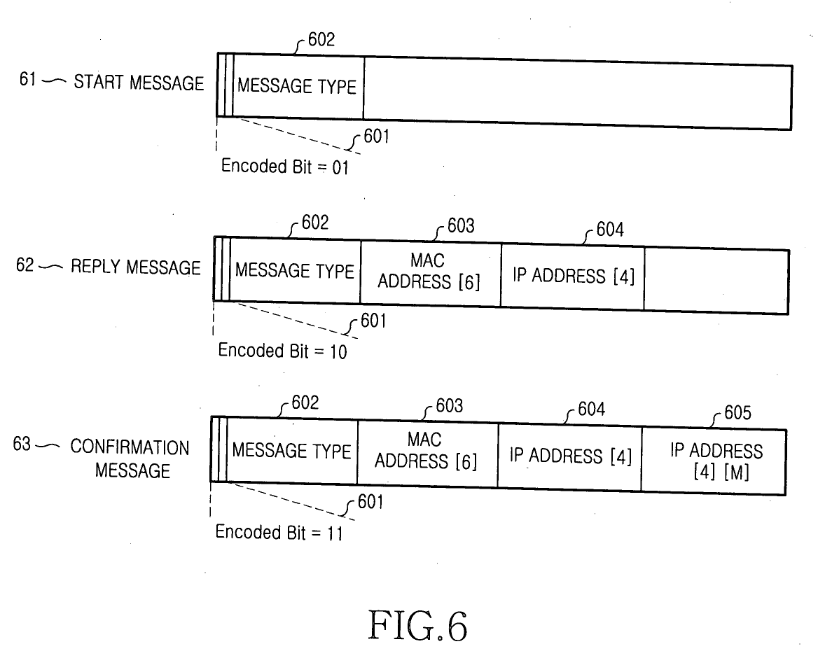

FIG. 6 is a view illustrating the structure of messages used in the discovery process according to an embodiment of the present invention.

As illustrated in FIG. 6, the messages used in the discovery process according to the embodiment of the present invention are classified into a start message 61, a reply message 62, and a confirmation message 63.

The start message 61 is composed of an encoded bit field 601 of two bits, and a message type field 602 for indicating a start request.

The reply message 62 is composed of an encoded bit field 601 of two bits, a message type field 602 for indicating a reply message, a MAC address field 603 for indicating a MAC address of a slave slot, and a slave IP address field 604 for indicating an IP address of the slave slot.

Meanwhile, the confirmation message 63 is composed of an encoded bit field 601 of two bits, a message type field 602 for indicating a confirmation message, a MAC address field 603 for indicating the MAC address of a slave slot, a slave IP address field 604 for indicating an IP address of the slave slot, and a master IP address field 605 for indicating an IP address of a master slot.

As described above, according to the present invention, applied protocols can be reduced by improving the conventional IP address management method and thus the amount of program codes can be reduced accordingly. Also, the removing/packaging of slots can accurately be found without any separate hardware device. Additionally, according to the present invention, by adjusting the transmission period, the reliability that is the weak point of the UDP protocol can be heightened. Furthermore, the method according to the present invention can be implemented by a program and stored in a recording medium (such as a CD ROM, RAM, floppy disk, hard disk, optomagnetic disk, etc.) in a computer-readable form.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for managing an IP address between slots for an IPC (Inter-Processor Communication), the method comprising:
a first step of, if a power of a slave slot is on, confirming whether the slave slot has a static IP, and if the slave slot does not have the static IP, confirming whether the corresponding slave slot has a DHCP (Dynamic Host Configuration Protocol) IP;
a second step of confirming whether the slave slot has a slot ID from a backplane if the slave slot has the static IP;
a third step of confirming whether the slave slot has the slot ID from the backplane if the slave slot has the DHCP IP;
a fourth step of confirming whether a master slot has a static IP, and if the master slot has the static IP, performing an IPC communication if the slave slot has the slot ID;
a fifth step of performing a discovery operation for obtaining IP information if the slave slot has neither the static IP nor the DHCP IP; and
a sixth step of performing the discovery operation for obtaining the IP information if the master slot does not have the static IP.

2. The IP management method as claimed in claim 1, further comprising a seventh step of terminating the process if the slave slot does not have the slot ID.

3. The IP management method as claimed in claim 1, wherein the discovery operation comprises:
an eighth step of the master slot periodically broadcasting a request message for a start of the IPC with respect to all of the slave slots;
a ninth step of the slave slot that has received the broadcast request message transmitting a reply message that includes a MAC address and an IP address of the slave slot to the master slot; and
a tenth step of the master slot transferring a confirmation message that includes the reply message and an IP address of the master slot to the slave slot.

4. The IP management method as claimed in claim 3, wherein the master slot performs its operation according to a size of a FIFO (First In First Out) buffer of the master slot if a plurality of reply messages is received from the slave slots.

5. The IP management method as claimed in claim 3, wherein the request message for the start is comprised of an encoded bit field of two bits and a message type field for indicating a start request.

6. The IP management method as claimed in claim 3, wherein the reply message is comprised of an encoded bit field of two bits, a message type field for indicating a reply message, a MAC address field for indicating a MAC address of a slave slot, and a slave IP address field for indicating an IP address of the slave slot.

7. The IP management method as claimed in claim 3, wherein the confirmation message is comprised of an encoded bit field of two bits, a message type field for indicating a confirmation message, a MAC address field for indicating a MAC address of a slave slot, a slave IP address field for indicating an IP address of the slave slot, and a master IP address field for indicating an IP address of a master slot.
